(19) United States
(12) Patent Application Publication
(10) Pub. No.: US 2009/0050576 A1
(43) Pub. Date: Feb. 26, 2009

(54) Method for Adjusting Chlorine Concentration In Salt Water Swimming Pools and Chloride Salts Dispenser Therefor

(76) Inventor: Paul Gement, Mandeville, LA (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/195,163

(22) Filed: Aug. 20, 2008

Related U.S. Application Data
(60) Provisional application No. 60/965,248, filed on Aug. 20, 2007.

(51) Int. Cl. C02F 1/76; C02F 1/66

(52) U.S. Cl. 210/754; 210/167.11; 210/192

(57) ABSTRACT

A method is provided for adjusting the chlorine concentration in salt water swimming pools having a pre-existing system for re-circulating the water including at least one skimmer, a pump, a chlorine generator for generating chlorine from chloride salts, a monitor for determining the chlorine concentration of the water, and an outlet for returning water to the pool. The method includes the steps of monitoring chlorine concentration in the swimming pool to determine whether the chlorine concentration is above or below a pre-established range, determining how much salt needs to be added to reach the desired chlorine concentration, supporting a hopper or other portable container of chloride salts above the skimmer, loading the dry bulk chloride salts into the hopper in the amount needed, manually initiating unattended flow of dry bulk chloride salts into the water in the skimmer from the hopper of chloride salts supported thereabove, and thereafter checking the chlorine concentration and making adjustments if needed. The apparatus of the invention includes a dispenser for chloride salts including a hopper having at least one sloping side, a bottom hand slide gate fixed to the hopper for unassisted gravity flow of salts, and a stand for supporting the hopper and gate.

### CROSS-REFERENCE TO RELATED APPLICATIONS

This application claims priority from Provisional Application Ser. No. 60/965,248 filed Aug. 20, 2007 for “A Device to Despence [sic] Granulated Salt into a Swimming Pool Skimmer” the contents of which are incorporated herein by reference in its entirety.

### FIELD OF THE INVENTION

This invention relates to salt water swimming pools, spas, ponds, and the like having a water recirculation system for treating the water typically including a skimmer, a pump, filters, a monitor for monitoring chlorine concentration, and a chlorine generator for generating chlorine from chloride salts dissolved in the water. More specifically, this invention relates to methods and apparatus for adjusting chlorine concentration.

### BACKGROUND OF THE INVENTION

Salt water swimming pools are pools in which the chlorine used to treat the water is obtained from chloride salts, most commonly sodium chloride. Sodium chloride has the advantage over liquid chlorine of being somewhat inert rather than highly caustic and is thus far more easily handled. Salt water swimming pools are similar to pools in which liquid chlorine is used, having a water recirculation system including a skimmer, filters, pumps, and a chlorine monitor for monitoring the concentration of water in the pool. Salt water pools also include a chlorine generator for generating chlorine from the electrolyte solution of chlorine ions formed when salt dissolves and dissociates in the water.

Typically, and especially for initial dosing of previously untreated water, the salt is added to the water by manually spreading the salt around the edges of the pool and then sweeping the salt into the pool. The salt dissolves and forms an electrolyte solution and the chlorine generator in the water recirculation system generates chlorine from the electrolyte.

Spreading and sweeping salt into a pool is somewhat labor intensive and time consuming. Several hundred pounds of salt may be needed to initially dose a pool, depending on the volume of water. Various systems have been proposed to solve aspects of these problems, including automated systems for monitoring chlorine concentration and dosing the pool with electrolyte solution. Fully automated chlorine dosing equipment is not always easily installed on existing water recirculation systems and can be costly to install and temperamental to maintain. Spreading and sweeping salt into the pool normally is still preferred for initial dosing.

It would be desirable to provide a reliable and consistent low cost method for creating a chloride electrolyte solution in pool water in response to a monitored chlorine concentration, which method is relatively easy to implement, even as a retrofit onto an existing salt water swimming pool. It would be desirable to provide an easy to use apparatus for implementing the method that reduces the amount of effort required to maintain a salt water pool and at a reasonable cost.

### SUMMARY OF THE INVENTION

The invention provides a method for creating a chloride ion electrolyte solution in swimming pool water from which chlorine can be generated and which can reduce substantially the labor intensive and time consuming practice of spreading salt around the pool and sweeping the salt into the water without the expense and potential complications of fully automated systems. The invention also provides a dispenser designed for virtually hands-free addition of dry bulk chloride salts to the pool water in response to monitored chlorine concentration. In exchange for a minimum of labor in loading chloride salts into the dispenser when the chlorine is low, the pool owner can initiate addition of chloride salts to the pool to achieve the desired chlorine concentration.

The method of the invention includes manually initiating an unattended addition of dry bulk granulated chloride salts to a contained body of water to create a chloride ion electrolyte solution in response to monitored chlorine concentration and for conversion of the electrolyte to chlorine, thereby establishing an initial chlorine concentration or adjusting a pre-established chlorine concentration. The contained body of water can include a swimming pool, a spa or hot tub, a pond, or other body of water having a recirculation system for treating the water that includes an inlet, a chlorine generator for generating chlorine from chlorine electrolyte, a chlorine concentration monitor, and a return to the body of water. Typically, the inlet includes a skimmer, usually located in a wall surrounding and containing the body of water, for initially removing floating debris from the water. The skimmer normally is accessible from the decking surrounding the wall, including the concrete or tile surface extending from the sides of a pool. The recirculation system also normally includes filters for additional filtration of the water and may include heaters for adjusting the water temperature.

In a more specific embodiment, the method of the invention includes the steps of supporting a container of chloride salts above the inlet to the water recirculation system; monitoring the chloride concentration in the body of water to determine the chlorine concentration in relation to a pre-determined chlorine concentration; and manually initiating unattended flow of dry bulk granulated chloride salts into the inlet from the container of chloride salts supported thereabove in response to the pre-determined chlorine concentration. In this manner, chloride salts may be added to the water in the absence of pre-dissolved salts, automated systems for adding chloride salts, manually pouring chloride salts into the water, and sweeping salts into the water. The operator determines how much salt needs to be added to achieve the desired concentration for the pool volume, loads that amount into the dispenser, initiates the addition, allows the resulting electrolyte solution to re-circulate for a suitable period of time, and then checks the chlorine concentration. Normally, the filters, chlorine generator, and chlorine monitor are turned off or bypassed during salt addition and for a circulation period.

The apparatus of the invention provides a container for chloride salts especially adapted for manually initiating the unattended flow of dry bulk chloride salts into the inlet of the contained body of water. In a specific embodiment, the apparatus includes a hopper having at least one downward sloping side for containing dry bulk chloride salts fitted with a bottom hand slide gate for unassisted gravity flow of chloride salts therethrough from said hopper. A stand supports said hopper and gate above an inlet to the water recirculation system for gravity feed of dry chloride salts through said gate into the water in the inlet. A storage bin can be provided above the hopper, if desired, which can include a removable lid for adding salt and for protecting the salt from the elements. The entire dispensing apparatus economically can be made from blow-molded or rotationally Howmolded plastic.

Thus, among other things, the invention provides a device for storing and dispensing dry bulk granulated sodium chloride, common table salt, into the skimmer of a salt water swimming pool, eliminating the practice of spreading salt around the edges of a pool and sweeping the salt into the pool and in the absence of an expensive retrofit. The invention requires no troublesome and expensive automated system for adding electrolyte solution. The pool attendant has only to place the portable dispenser over the skimmer as a stand-alone device and align the device for dispensing salt into the water in the skimmer, determine the amount of salt to be added to the pool to achieve the desired chlorine concentration, and thereafter to fill the device with salt, initiate the addition of the salt to the pool, allow the water to circulate, and monitor the chlorine content of the water, without otherwise having continually to attend to the salt addition.

### BRIEF DESCRIPTION OF THE DRAWINGS

FIG. 1 is a cutaway perspective view of the apparatus of the invention placed in salt dispensing communication with water in the skimmer of a salt water swimming pool;

FIG. 2 is an exploded partial perspective view of the hopper and a portion of a storage bin of the apparatus of the invention with the hand slide gate assembly exploded therefrom;

FIG. 3 is a bottom plan view of the hand slide gate assembly of the invention in a closed position;

FIG. 4 is a bottom plan view of the hand slide gate assembly of the invention in an open position;

FIG. 5 is a longitudinal axial section through the hopper and closed hand slide gate of the invention taken along line 5-5 of FIG. 3;

FIG. 6 is a longitudinal axial section through the hopper and open hand slide gate of the invention taken along line 6-6 of FIG. 4;

FIG. 7 is a schematic diagram of a salt water swimming pool having a basic water recirculation system including a slat dispenser of the invention placed over the skimmer at the pool surface inlet to the recirculation system, a pump, filter, chlorine generator and monitor, and return line and drain; and

FIG. 8 is a flow diagram illustrating the sequence of steps of a basic method of the invention.

Corresponding reference characters indicate corresponding parts throughout the several views of the drawings.

### DETAILED DESCRIPTION

This invention can best be understood with reference to specific embodiments that are illustrated in the accompanying drawings and the variations described hereinbelow. While the invention will be so described, it should be recognized that the invention is not intended to be limited to the embodiments illustrated in the drawings. On the contrary, the invention includes all alternatives, modifications, and equivalents that may be included within the scope and spirit of the invention as defined by the appended claims.

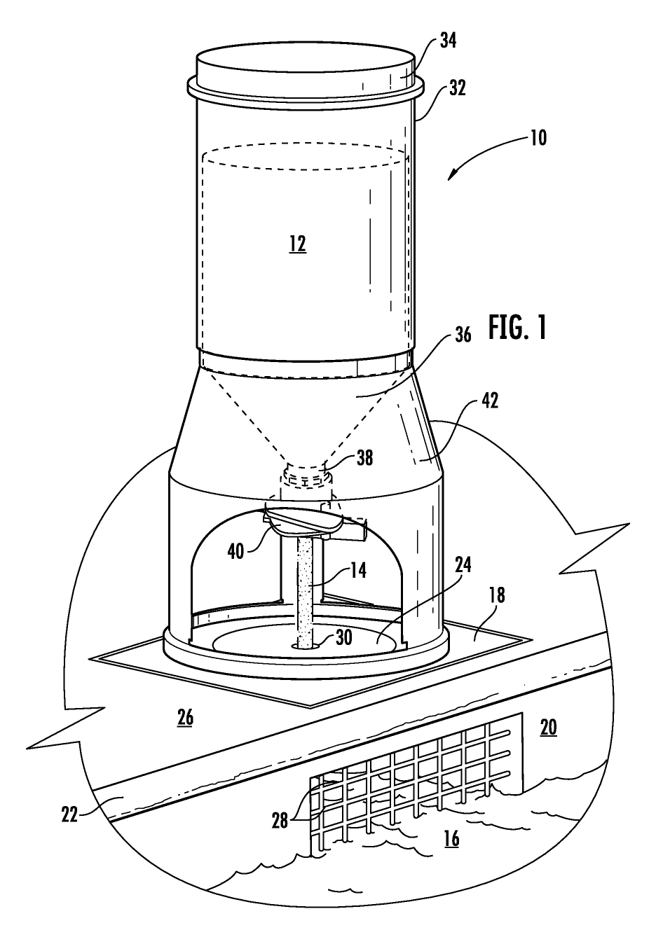

FIG. 1 illustrates generally at 10 a cutaway perspective view an apparatus 12 of the invention dispensing chloride salt 14 into the water 16 in the skimmer 18 of a swimming pool basin 20 defined by a vertical pool wall 22. The skimmer has a removable round access lid 24 located on the deck 26 about the pool basin. Deck 26 is a horizontal surface typically of tile or concrete. The skimmer includes a grate 28 located in the wall 22 through which water 16 enters. The salt dispensing apparatus 12 sits atop the skimmer and is aligned in salt flowing communication with the skimmer access lid 24. Salt 14 flows into the water in the skimmer through an opening 30 in the skimmer lid 24.

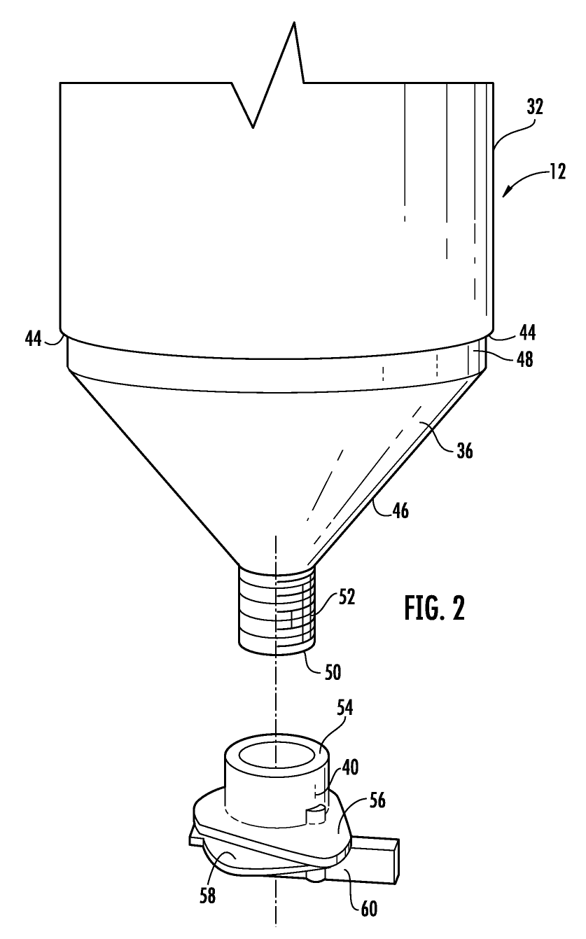

Salt dispenser 12 includes a cylindrical storage bin 32 for dry bulk granulated sodium chloride 14, which is shown in dashed lines in FIG. 1. Removable lid 34 seals the salt in the bin against exposure to the elements and can be removed as needed to add more salt to the bin. A conical hopper 36 beneath the storage bin is reflected by the dashed outline of the salt, terminating in a threaded cylinder 38 to which is screwed a hand slide gate 40. Hopper 36 can best be seen in FIG. 2, which is discussed below.

Salt flows from the storage bin 32 through the hopper 36 and hand slide gate 40 through the opening 30 in the skimmer lid 24. A stand 42 alignedly supports the storage bin, hopper, and hand slide gate above the skimmer 18.

The storage bin, hopper, and stand desirably are made from the same materials to avoid differences in rate of thermal expansion and to reduce the impact of temperature changes on the apparatus. Typically, blow-molded or rotationally molded plastics, including polyethylene, offer the most economical preparation. Non-reactive sheet metal, normally stainless steel, can also be used. The hand slide gate typically will be injection molded plastic for trouble free operation.

Stand 42 has a roughly cylindrical base with an upwardly tapered conical portion engaging a lip 44 on the storage bin, which lip can best be viewed in FIG. 2, to support the cylindrical storage bin, salt, hopper, and bottom hand slide gate above the skimmer lid. Portions of the stand base are cut away to reduce weight, reduce the amount of plastic used, and to increase rigidity. The base terminates in an annular portion about the skimmer lid 24 so as to provide a passage for salt flow into the skimmer and for providing a horizontal surface for mounting on a substantially horizontal surface 18 of the pool decking 26. Other configurations readily should come to mind having knowledge of the invention for mounting the salt dispenser to decks about spas, hot tubs, ponds, above ground pools, and the like contained bodies of water to which the invention may be applied.

Turning now to a discussion of the apparatus as illustrated in FIG. 2, FIG. 2 shows generally at 12, and in a partial front perspective view, the apparatus of the invention shown at 12 in FIG. 1. FIG. 2 illustrates hand slide gate 40 exploded from the hopper 36 and storage bin 32. Hopper 36 is of conical design having downwardly tapered sidewalls 46, a horizontal and vertically extended circular upper terminus 48 coextensive with the storage bin 32 and a parallel circular lower terminus 50 of smaller diameter extending from cylinder 38 (FIG. 1). The cylinder is threaded with threads 52 for screwing the hand slide gate onto the hopper.

The hopper should have at least one downwardly sloping side for unassisted gravity flow of dry bulk salts from the storage bin and through the hand slide gate. For example, the hopper can be configured with a square or rectangular body mounted to a similarly configured storage bin and having one side sloping downwardly from the bin to convey salt to a similarly configured hand slide gate. It should readily be envisioned that a hopper can be configured to serve both for salt storage and for unassisted flow in the absence of a separate storage bin, if desired.

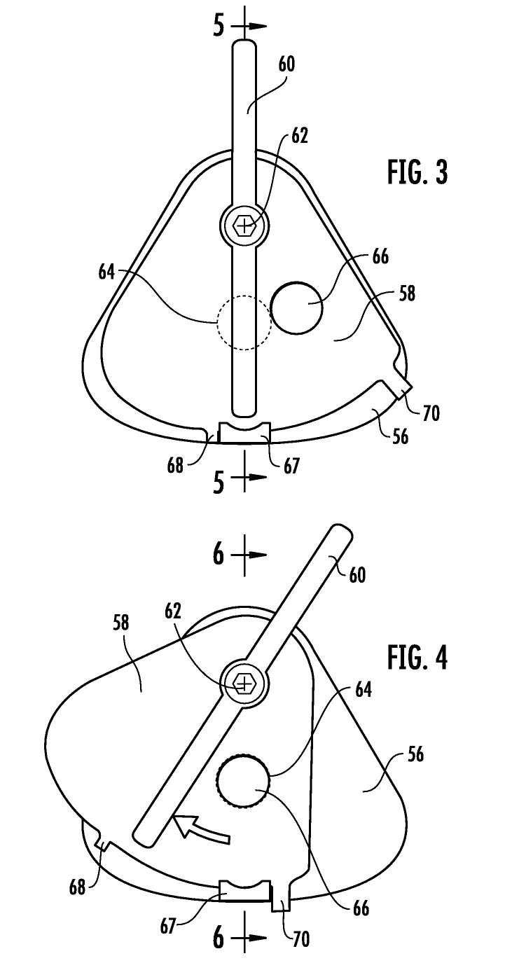

The hand slide gate 40 has a corresponding threaded member 54 for threadedly engaging threaded hopper cylinder 52. The hand slide gate 40 includes a pair of horizontally oriented and slidably communicating plates 56 and 58, each said plate having an opening therein, which opening can be seen in FIGS. 3 and 4. A horizontally oriented rotatable stem 60 extends from one of the plates, the lower plate 58, and is rigidly fixed thereto.

Turning now to FIGS. 3 and 4, FIG. 3 illustrates the hand slide gate in a plan bottom view and shows the gate completely closed with the openings 64 and 66 unaligned and precluding salt from flowing therethrough. Stem 60 has been rotated until a projection 67 on the upper plate 56 engages a limit stop 68 on the lower plate.

FIG. 4 illustrates the hand slide gate in a plan bottom view and shows the gate completely open with the openings 64 and 66 aligned and providing maximum flow of salt therethrough. Stem 60 has been rotated in the opposite direction of closing until projection 67 on the upper plate 56 engages a limit stop 70 on the lower plate. The stem 60 is manually rotatable about a vertical axis 62 for axially aligning the openings 64 and 66 in said plates 56 and 58, respectively, whereby dry bulk chloride salts 14 (FIG. 1) flow through the aligned openings 64, 66 into the water 16 in the skimmer 18, which is the inlet of the water recirculation system in FIG. 1.

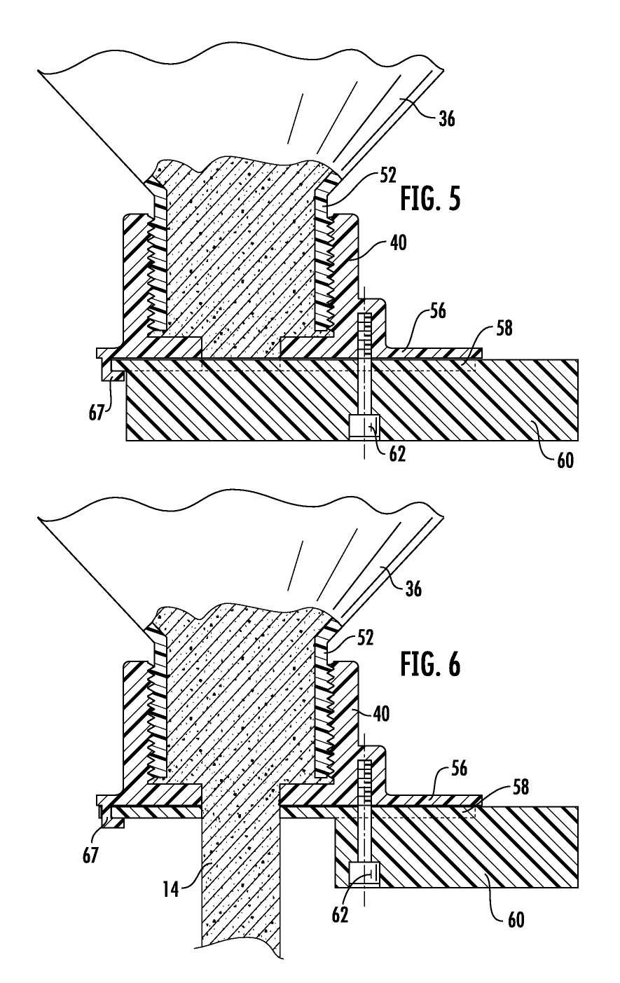

FIG. 5 is a partial longitudinal and axial section taken along line 5-5 of FIG. 3. FIG. 5 shows the threaded engagement of the cylindrical terminus of the hopper with the hand slide gate. Stem 60 and plate 58 have been rotated about screw 62 to close the hand slide gate by rotating openings 64 and 66 (FIG. 3) out of axial alignment so that plate 58 blocks flow through opening 64 in upper plate 56.

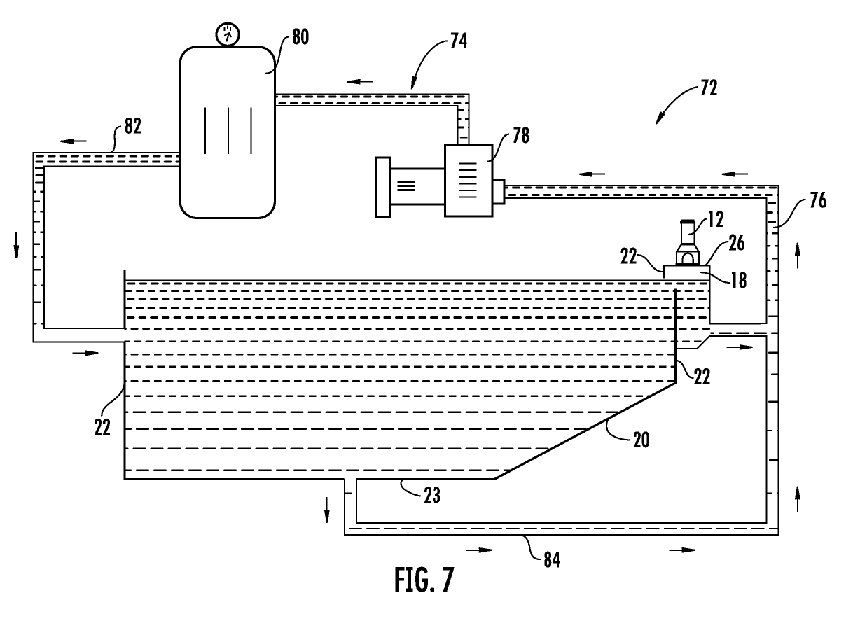

FIG. 6 is a partial longitudinal and axial section taken along line 6-6 of FIG. 4. FIG. 6 shows the threaded engagement of the cylindrical terminus of the hopper 36 with the hand slide gate 40. Stem 60 and plate 58 have been rotated about screw 62 to fully open the hand slide gate by rotating openings 64 and 66 (FIG. 4) into axial alignment so that plate 58 no longer blocks flow through opening 64 in upper plate 56.

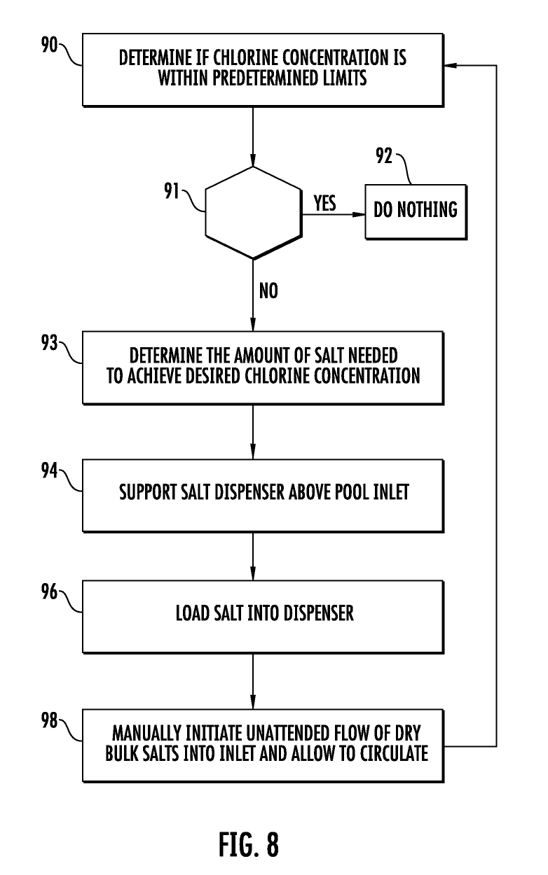

Turning now to a discussion of the salt dispenser in the context of its use in a salt water swimming pool, FIG. 7 is a highly schematic illustration of a salt water swimming pool shown generally at 72. The pool includes basic elements for treating the water and has a basin 20 having walls 22 and a bottom 23 for containing water for swimming or bathing and a recirculation system shown generally at 74. A deck 26 surrounds at least a portion of the pool basin. Only a portion of the deck is illustrated.

The water recirculation system shown generally at 74 includes piping 76 and at least one skimmer 18 in the pool wall 22 for receiving water from the basin 20 and accessible from the deck 26. The water recirculation system normally also includes a pump 78 in fluid flow communication with the skimmer 18, a chlorine generator, chlorine concentration monitor, and filters shown in combination at 80 for generating chlorine from chloride salts, determining chlorine concentration in the water, and filtering the water, and a return line 82 for pumping water back into the pool. The generator, monitor, and filter would typically be separate elements and are shown here in combination for convenience and do not form part of the invention except as used in combination in the method of the invention. A drain line 84 normally is also provided. Heaters may be included in some pools.

An apparatus 12 of the invention is shown mounted above the skimmer and in salt flow communication therewith for adding salt to the water in the pool to create an electrolyte solution. The salt enters the pool through the skimmer as the inlet to the recirculation system and the resulting electrolyte solution can be used to make chlorine in the generator at 80 when initially charging the pool and for maintenance in response to monitored chlorine content. The filters, generator and monitor would typically be taken off line or bypassed while the salt is being added and initially recirculated, for a period of 24 to 48 hours, before chlorine is generated and the concentration checked.

The apparatus 12 includes a storage bin for unassisted mass flow of dry bulk chloride salts therefrom, a hopper in flow communication with the storage bin and having at least one downward sloping side for gravity flow of dry chloride salts, a bottom hand slide gate fixed to the hopper for unassisted gravity flow of chloride salts therethrough from the hopper, and a stand for supporting the hopper and gate on the pool deck above a skimmer for gravity feed of dry chloride salts through the gate into the water in the skimmer. Chlorine is generated from the salts by the chlorine generator. The chlorine concentration of the water is monitored. The operator adds salt to the storage bin and hopper in the amount desired to achieve a pre-selected chlorine concentration, opens the hand slide gate to add the salt to the pool water, and thereafter, after a suitable period of recirculation, checks the chlorine concentration to make adjustments as needed.

On initially charging the pool, the operator may need to fill the storage bin and hopper several times to add the requisite projected amount of salt to achieve the desired chlorine concentration. After allowing the water to re-circulate for an extended period, perhaps 24 hours, the operator may then make adjustments as needed. Maintenance doses typically require much smaller additions in response to an indication that the chlorine content has dropped to a lower limit, say below 2400 ppm.

It should be recognized that the term “hand slide gate” refers to the name provided for the valve used to start and stop salt addition. Although referred to herein as a hand slide gate, it should be recognized that the operator may use a foot or stick to rotate the stem on the plate member of the slide gate without departing from the spirit of the invention. It should also be recognized that, although the gate is shown in FIGS. 3 and 4 in its fully closed and fully opened positions, respectively, the operator has the flexibility to adjust the size of the opening between these two extremes to adjust the rate of unassisted mass flow through the slide gate. Also, while the salts are referred to as “dry bulk granulated chloride salts,” the term simply means that the salts are not dissolved to form an electrolyte solution in the dispenser and are flowable in an unassisted mass flow dispenser. “Dry” should not be used as a synonym for “anhydrous” in this context.

In operation, and with reference to FIG. 8, the pool owner or attendant typically will monitor the chlorine concentration of a swimming pool in accordance with step 90. The chlorine monitor provides an indication of the chlorine concentration in the pool. If the chlorine concentration is determined to be within a desirable range, as in step 91, then the operator need do nothing as in step 92. If the chlorine concentration is too low in step 91, or if the pool water is untreated, then operator determines the amount of salt needed to achieve the desired chlorine concentration given the volume of the pool and existing chlorine concentration, in accordance with step 93. The operator places the salt dispenser above the skimmer or other suitable inlet location so that the dispenser is supported above the pool inlet in aligned dry bulk granulated salt mass flow communication with the inlet, as set forth in step 94. Thereafter, the attendant loads the dispenser with salt as in step 96 and manually initiates unattended flow, as set forth in step 98. The operator adds the salt to the pool by opening and adjusting the hand slide gate and filling the salt dispenser as many times as needed with as much salt is indicated to establish or adjust the chlorine concentration.

After a suitable period of re-circulation of the resulting electrolyte solution and conversion to chlorine, the operator turns on the generator and monitor and again monitors the chlorine concentration, step 90, to determine if the chlorine concentration has been correctly adjusted and thereafter makes adjustments as needed. Once the desired chlorine concentration is reached, then a pool operator normally may need to check the treated pool once a week or once a month to determine if additional salt is needed, depending on conditions.

Thus, with minimal effort, the pool operator has eliminated the strenuous, time consuming task of sweeping salt into the pool, and has eliminated adding electrolyte solution, liquid chlorine, and using an expensive and troublesome automated system to add electrolyte.

The invention has been described with reference to specific embodiments. However, variations can be made within the scope and spirit of the invention as described in the foregoing specification as defined in the appended claims.

What is claimed is:

1. A method for adjusting the chlorine concentration of a body of water comprising the steps of
a) manually initiating an unattended addition of a pre-determined amount of dry bulk chloride salts to a contained body of water;
b) circulating the water to create an electrolyte solution; and
c) generating chlorine from the electrolyte solution.

2. A method for adjusting the chlorine concentration of a body of water having a system for re-circulating the water including an inlet, a pump, a chlorine generator for generating chlorine from chloride salts, a monitor for determining the chlorine concentration of the water, and an outlet for returning water to the body of water, said method comprising the steps of:
a) supporting a container of chloride salts above the inlet to the water re-circulating system;
b) monitoring chlorine concentration in the body of water to determine whether the chlorine concentration is below a pre-determined range;
c) determining the amount of chloride salts needed to bring the chlorine concentration into the pre-determined range; and
d) manually initiating unattended flow of dry bulk chloride salts into the inlet from the container of chloride salts supported thereabove whereby chloride salts may be added to the water in the absence of pre-dissolved salts, automated systems for adding chloride salts, manually pouring chloride salts into the water, and sweeping salts into the water.

3. The method of claim 2 wherein the body of water is a swimming pool and the inlet to the water re-circulating system is a skimmer, and wherein the step of supporting a container of chloride salts above the skimmer comprises the steps of:
a) supporting a hopper having at least one downwardly sloping side and a bottom hand slide gate attached thereto above the skimmer so that dry bulk chloride salts will flow into the water in the skimmer when the hand slide gate is open; and
b) loading dry bulk chloride salts into the hopper.

4. The method of claim 3 wherein the step of manually initiating unattended flow of dry bulk chloride salts into the water in the skimmer comprises manually opening the hand slide gate.

5. The method of claim 3 further comprising the step of adjusting the opening of the hand slide gate to adjust the rate of flow of chloride salts therefrom.

6. The method of claim 2 wherein the water re-circulation system is a pre-existing system and the method further comprises the steps of providing a manually operable portable container for chloride salts and a support for the container, whereby the container may be carried to the inlet and placed above it on the support as a stand-alone device.

7. A method for adjusting the chlorine concentration of a swimming pool having a pre-existing system for re-circulating the water including at least one skimmer, a pump, a chlorine generator for generating chlorine from chloride salts, a monitor for determining the chlorine concentration of the water, and an outlet for returning water to the pool, said method comprising the steps of:
a) supporting a hopper having at least one downwardly sloping side and a bottom hand slide gate attached thereto above the skimmer;
b) loading dry bulk chloride salts into the hopper;
c) monitoring chlorine concentration in the swimming pool to determine whether the chlorine concentration is below a pre-determined range;
d) manually opening the hand slide gate to initiate unattended flow of dry bulk chloride salts into the water in the skimmer from the hopper of chloride salts supported thereabove when the monitored chlorine concentration is below a pre-determined range; and
e) adding sufficient salt to bring the chlorine concentration within the pre-determined range.

8. The method of claim 7 wherein the skimmer is accessible from the deck of a swimming pool and the step of supporting a hopper above the skimmer comprises placing the hopper in a support on the deck of the pool above the skimmer.

9. The method of claim 7 further comprising the step of adjusting the rate of flow of dry bulk chloride salts from the hopper by adjusting the hand gate.

10. A salt water swimming pool comprising:
a) a basin for water, said basin having walls and a bottom;
b) a deck surrounding at least a portion of said pool basin;
c) a water recirculation system including at least one skimmer in the pool wall for receiving water from said basin and accessible from said deck, a pump connected to said skimmer, a chlorine generator in the recirculation system for generating chlorine from chloride salts, a monitor in the recirculation system for determining chlorine concentration in the water, and a return line for pumping water back into the pool;
d) a storage bin for unassisted mass flow of dry bulk chloride salts therefrom;
e) a hopper in flow communication with said storage bin and having at least one downward sloping side for gravity flow of dry chloride salts;
f) a bottom hand slide gate fixed to said hopper for unassisted gravity flow of chloride salts therethrough from said hopper; and
g) a stand for supporting said hopper and gate on the pool deck above a skimmer for gravity feed of dry chloride salts through said gate into the water in the skimmer, whereby chlorine is generated from the salts by the chlorine generator, the chlorine concentration of the water is monitored, and the storage bin filled and the gate opened by an operator in response to the chlorine concentration.

11. Apparatus for dispensing chloride salts into a contained body of water, the contained body of water having in fluid flow communication therewith a water recirculation system including at least one inlet, a pump, a chlorine generator for generating chlorine from chloride salts, a monitor for determining chlorine concentration in the water, and an outlet for returning water to the body of water, said apparatus comprising:
a) a hopper having at least one downward sloping side for containing dry bulk chloride salts;
b) a bottom hand slide gate fixed to said hopper for unassisted gravity flow of chloride salts therethrough from said hopper; and
c) a stand for supporting said hopper and gate above an inlet to the water recirculation system for gravity feed of dry chloride salts through said gate into the water in the inlet, whereby chlorine is generated from the salts by the chlorine generator, the chlorine concentration of the water is monitored, and the hopper filled and the gate opened by an operator in response to the chlorine concentration.

12. Apparatus of claim 11 further comprising a storage bin for containing dry bulk chloride salts in solids flow communication with said hopper opposite said gate.

13. Apparatus of claim 12 wherein said storage bin is a mass flow storage bin of cylindrical design and includes an upper removable lid opposite said hopper for sealing said bin against the elements in a closed position and for adding chloride salts to said bin when removed.

14. Apparatus of claim 13 wherein said hopper is of conical design having a horizontal circular upper terminus coextensive with said storage bin and a parallel circular lower terminus of smaller diameter terminating in a threaded cylinder, and wherein said hand slide gate is screwed onto said threaded cylinder.

15. Apparatus of claim 11 wherein said hand slide gate is injection molded plastic.

16. Apparatus of claim 11 wherein said hopper is roto-molded or blow-molded plastic.

17. Apparatus of claim 11 wherein said hand slide gate comprises a pair of horizontally oriented and slidably communicating plates, each said plate having an opening therein, and a horizontally oriented stem extending from one of said plates and rigidly fixed thereto, said stem being manually rotatable about a vertical axis for axially aligning the openings in said plates, whereby dry bulk chloride salts flow through said aligned openings into the water in the inlet of the water recirculation system.

18. Apparatus of claim 17 wherein said hand slide gate includes limit stops for adjusting the alignment of the openings in the slidable plates from a fully closed position to a fully opened position, whereby the rate of flow of chloride salts may be adjusted.

19. Apparatus of claim 11 wherein the inlet is a skimmer and said stand supports said hopper above said skimmer for gravity flow of chloride salts into water in said skimmer.

20. Apparatus for dispensing chloride salts into a swimming pool having a water recirculation system including at least one skimmer, a pump, a chlorine generator for generating chlorine from chloride salts, and a monitor for determining chlorine concentration in the water, said apparatus comprising:
a) a storage bin for unassisted mass flow of dry bulk chloride salts therefrom;
b) a hopper in flow communication with said storage bin and having at least one downward sloping side for gravity flow of dry chloride salts;
c) a bottom hand slide gate fixed to said hopper for unassisted gravity flow of chloride salts therethrough from said hopper; and
d) a stand for supporting said hopper and gate above a skimmer for gravity feed of dry chloride salts through said gate into the water in the skimmer, whereby chlorine is generated from the salts by the chlorine generator, the chlorine concentration of the water is monitored, and the storage bin filled and the gate opened by an operator in response to the chlorine concentration.
